(19) United States
(12) Patent Application Publication
(10) Pub. No.: US 2022/0410901 A1
(43) Pub. Date: Dec. 29, 2022

(54) INITIALIZING EARLY AUTOMATIC LANE CHANGE

(71) Applicant: GM Global Technology Operations LLC, Detroit, MI (US)

(72) Inventors: Namal P. Kumara, Ypsilanti, MI (US); Paul A. Adam, Milford, MI (US); Gabriel Tayoung Choi, Novi, MI (US)

(21) Appl. No.: 17/360,470

(22) Filed: Jun. 28, 2021

(51) Int. Cl. B60W 30/18; B60W 30/09; B60W 30/095; B60W 60/00; B60W 40/04; G06K 9/00

(52) U.S. Cl. CPC B60W 30/18163; B60W 30/09; B60W 30/0956; B60W 60/0015; B60W 40/04; G06K 9/00805; B60W 2554/80

(57) ABSTRACT

A method of initializing an automatic lane change in a moving primary automobile, including categorizing, via a controller within the primary automobile, a moving automobile that is in front of the primary automobile as a target automobile, categorizing, via the controller within the primary automobile, an object in front of both the primary automobile and the target automobile as one of a low confidence object and a high confidence object, initializing, via the controller within the primary automobile, the automatic lane change for the primary automobile when the object is categorized as a high confidence object, and initializing, via the controller within the primary automobile, the automatic lane change for the primary automobile when the object is categorized as a low confidence object and a lane change of the target automobile is detected by at least one of a plurality of sensors within the automobile.

### INTRODUCTION

The present disclosure relates to automatic lane changes in a moving automobile when an object is detected in front of the moving automobile in an adjacent lane or in the same lane as the moving automobile, and more particularly to a method of initiating an early automatic lane change.

Modern automobiles are equipped with many sensors to detect the presence of objects that are near the automobile. Some automobiles are equipped to initiate an automatic lane change when these sensors detect an object in front of the automobile as the automobile is moving on a road or highway. For example, if the automobile is moving in the furthest right lane of a road or highway and the sensors detect an object, such as a disabled automobile or an emergency automobile sitting stationary on the shoulder of the road or highway, a controller will initiate an automatic lane change to move the automobile from the furthest right lane to the lane adjacent the furthest right lane on the left. In another example, if the automobile is moving in any lane on a road or highway and the sensors detect an object, such as a automobile directly in front of the moving automobile, in the same lane, that is either stopped or moving significantly slower than the moving automobile, a controller will initiate an automatic lane change to move the automobile from its current lane to an adjacent lane to the right or left.

The sensors in the automobile are positioned at different locations and different orientations to effectively monitor the presence of objects all around the automobile. Because of the different locations and different orientations, typically, as a moving automobile approaches an object in front of it, the object will be detected first by a single sensor that, due to its location and orientation, is optimally situated to detect the object. Thereafter, as the automobile gets closer to the object, other sensors will detect the object as well. When a single sensor detects the presence of an object in front of the automobile, the object is categorized as a low confidence object. When more than one sensor detects the presence of an object in front of the automobile, the object is categorized as a high confidence object. To avoid unnecessary lane changes, typically an automatic lane change is initiated only upon detection of a high confidence object.

Optimally, the automatic lane change will be complete before the moving automobile reaches critical distance at which host needs to start reacting to the object (typically by slowing down). Depending on the relative velocity of host automobile and target object, there is a time window within which the automatic lane change must be completed. The larger relative velocity of host vs target vehicle, the quicker the moving automobile will reach the object, and less time will be available for the automatic lane change.

Thus, while current methods of initiating an automatic lane change in a moving automobile achieve their intended purpose, there is a need for a new and improved method for using the detection of a lane change by a second moving automobile in combination with the detection of a low confidence object by a first automobile to initiate an early automatic lane change of the first automobile.

### SUMMARY

According to several aspects of the present disclosure, a method of initializing an automatic lane change in a moving primary automobile, includes categorizing, via a controller within the primary automobile, a moving automobile that is in front of the primary automobile as a target automobile; categorizing, via the controller within the primary automobile, an object in front of both the primary automobile and the target automobile as one of a low confidence object and a high confidence object; initializing, via the controller within the primary automobile, the automatic lane change for the primary automobile when the object is categorized as a high confidence object; and initializing, via the controller within the primary automobile, the automatic lane change for the primary automobile when the object is categorized as a low confidence object and a lane change of the target automobile is detected by at least one of a plurality of sensors within the automobile.

According to another aspect, the categorizing, via the controller within the primary automobile, the moving automobile that is in front of the primary automobile as a target automobile further includes detecting the moving automobile that is in front of the primary automobile with at least one of a plurality of sensors within the primary automobile, and communicating the detection of the moving automobile that is in front of the primary automobile to the controller.

According to another aspect, the method further includes monitoring the target automobile with at least one of the plurality of sensors within the primary automobile to detect a lane change by the target automobile and communicating the lane change of the target automobile to the controller within the primary automobile.

According to another aspect, the categorizing the object in front of both the primary automobile and the target automobile as one of a low confidence object and a high confidence object further includes detecting the object with at least one of the plurality of sensors within the primary automobile and communicating the detection of the object to the controller.

According to another aspect, the categorizing the object in front of both the primary automobile and the target automobile as one of a low confidence object and a high confidence object further includes categorizing, with the controller, the object as a low confidence object when the object is detected by only one of the plurality of sensors within the primary automobile.

According to another aspect, the categorizing the object in front of both the primary automobile and the target automobile as one of a low confidence object and a high confidence object further includes categorizing, with the controller, the object as a high confidence object when the object is detected by more than one of the plurality of sensors within the primary automobile.

According to another aspect, the object is a stationary object that is located in one of the same lane as the primary automobile and a lane adjacent to a lane in which the primary automobile is moving.

According to another aspect, the object is an object that is moving slower than the primary automobile in one of the same lane as the primary automobile and a lane adjacent to a lane in which the primary automobile is moving.

According to another aspect, the method further includes verifying that conditions are safe for the automatic lane change prior to initializing the automatic lane change.

According to another aspect, verifying that conditions are safe for the automatic lane change prior to initializing the automatic lane change further includes detecting, with the plurality of sensors within the primary automobile, the presence of secondary automobiles around the primary automobile and communicating the presence of secondary automobiles around the primary automobile to the controller.

According to another aspect, verifying that conditions are safe for the automatic lane change prior to initializing the automatic lane change further includes categorizing, with the controller, each secondary automobile detected around the primary automobile as one of significant, wherein the secondary automobile will interfere with the automatic lane change of the primary automobile, and insignificant, wherein the secondary automobile will not interfere with the automatic lane change of the primary automobile.

According to another aspect, the initializing, via the controller within the primary automobile, the automatic lane change for the primary automobile when the object is categorized as a high confidence object further includes initializing, via the controller within the primary automobile, the automatic lane change for the primary automobile when the object is categorized as a high confidence object and all secondary automobiles detected around the primary automobile are categorized as insignificant; and initializing, via the controller within the primary automobile, the automatic lane change for the primary automobile when the object is categorized as a low confidence object and a lane change of the target automobile is detected by at least one of a plurality of sensors within the automobile further includes initializing, via the controller within the primary automobile, the automatic lane change for the primary automobile when the object is categorized as a low confidence object and a lane change of the target automobile is detected by at least one of the plurality of sensors within the automobile and all secondary automobiles detected around the primary automobile are categorized as insignificant.

According to several aspects of the present disclosure, a system for controlling an automatic lane change within a moving primary automobile, includes a plurality of sensors mounted within the primary automobile, and a controller in communication with the plurality of sensors, wherein, each of the plurality of sensors is adapted to detect a moving automobile that is in front of the primary automobile and the controller is adapted to categorize the moving automobile that is in front of the primary automobile as a target automobile, each of the plurality of sensors is adapted to detect an object in front of both the primary automobile and the target automobile and the controller is adapted to categorize the object in front of both the primary automobile and the target automobile as one of a low confidence object and a high confidence object, the controller is adapted to initialize the automatic lane change for the primary automobile when the object is categorized as a high confidence object, and the controller is adapted to initialize the automatic lane change for the primary automobile when the object is categorized as a low confidence object and a lane change of the target automobile is detected by at least one of the plurality of sensors within the automobile.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of an automobile including a system according to an exemplary embodiment of the present disclosure;

FIG. 2 is a schematic illustrating an automatic lane change of a primary automobile initiated when a high confidence object has been detected in front of the primary automobile;

FIG. 3 is a schematic illustrating the detection by a primary automobile of a lane change of a target vehicle;

FIG. 4 is a schematic illustrating a automatic lane change of a primary automobile initiated when a low confidence object has been detected and a lane change of a target automobile has been detected;

FIG. 5 is top view of a primary vehicle surrounded by secondary automobiles; and

FIG. 6 is a flow chart illustrating a method of controlling automatic lane changes according to an exemplary embodiment.

### DETAILED DESCRIPTION

The following description is merely exemplary in nature and is not intended to limit the present disclosure, application, or uses.

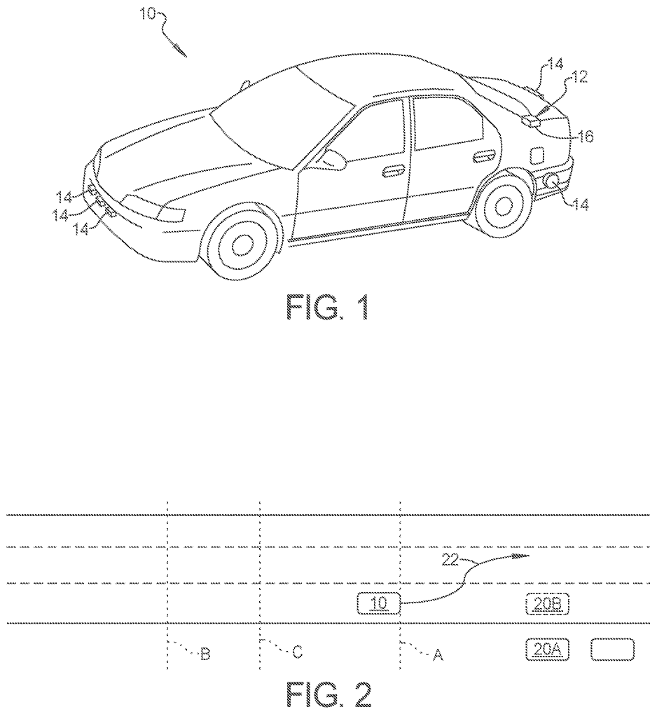

Referring to FIG. 1, a primary automobile 10 including a system 12 for controlling an automatic lane change within the primary automobile 10, includes a plurality of sensors 14 mounted within the primary automobile 10, and a controller 16 in communication with the plurality of sensors 14.

The plurality of sensors 14 allow the primary automobile 10 to see and sense everything on the road, as well as to collect the information needed in order to drive safely. Furthermore, this information is processed and analyzed by the controller 16 in order to build a path and to send the appropriate instructions to the controls of the primary automobile 10, such as steering, acceleration, and braking.

The plurality of sensors 14 is made up of different sensor types including, but not limited to, cameras, radars, and lidars. Video cameras and sensors see and interpret objects in the road just like human drivers do with their eyes. Typically, video cameras are positioned around the automobile at every angle to maintain a 360 degree view around the automobile and providing a broader picture of the traffic conditions around them. Video cameras display highly detailed and realistic images, and automatically detect objects, such as other cars, pedestrians, cyclists, traffic signs and signals, road markings, bridges; and guardrails, classify them, and determine the distances between them and the automobile.

Radar (Radio Detection and Ranging) sensors send out radio waves that detect objects and gauge their distance and speed in relation to the automobile in real time. Both short range and long range radar sensors may be included in the plurality of sensors 14. Lidar (Light Detection and Ranging) sensors work similar to radar sensors, with the only difference being that they use lasers instead of radio waves. Apart from measuring the distances to various objects on the road, lidar allows creating 3D images of the detected objects and mapping the surroundings. Moreover, lidar can be configured to create a full 360-degree map around the automobile rather than relying on a narrow field of view.

The system controller 16 is a non-generalized, electronic control device having a preprogrammed digital computer or processor, memory or non-transitory computer readable medium used to store data such as control logic, software applications, instructions, computer code, data, lookup tables, etc., and a transceiver or input/output ports. Computer readable medium includes any type of medium capable of being accessed by a computer, such as read only memory (ROM), random access memory (RAM), a hard disk drive, a compact disc (CD), a digital video disc (DVD), or any other type of memory. A “nontransitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

Each of the plurality of sensors 14 is adapted to detect a moving automobile that is in front of the primary automobile 10. The controller 16 is adapted to categorize the moving automobile that is in front of the primary automobile 10 as a target automobile 18. The target automobile 18 is generally moving at close to the same speed as the primary automobile 10 and traveling in the same lane as the primary automobile 10.

Further, each of the plurality of sensors 14 is adapted to detect an object 20 in front of both the primary automobile 10 and the target automobile 18 that is either stationary or moving significantly slower than the primary automobile 10 and in the same lane as the primary automobile 10 or a lane that is immediately adjacent the primary automobile 10. The controller 16 is adapted to categorize the object 20 in front of both the primary automobile 10 and the target automobile 18 as one of a low confidence object and a high confidence object.

In an exemplary embodiment, the controller 16 is adapted to categorize the object 20 in front of both the primary automobile 10 and the target automobile 18 as a low confidence object when the object 20 is detected by only one of the plurality of sensors 14 within the primary automobile 10, and the controller 16 is adapted to categorize the object 20 in front of both the primary automobile 10 and the target automobile 18 as a high confidence object when the object 20 is detected by more than one of the plurality of sensors 14 within the primary automobile 10.

Because of the different locations and different orientations of each of the plurality of sensors 14, as the primary automobile 10 approaches an object 20 in front of it, the object 20 will be detected first by a single one of the plurality of sensors 14 that, due to its location and orientation, is optimally situated to detect the object 20. Thereafter, as the primary automobile 10 gets closer to the object 20, other ones of the plurality of sensors 14 will detect the object 20 as well. When a single one of the plurality of sensors 14 detects the presence of an object 20 in front of the primary automobile 10, the object 20 is categorized as a low confidence object. When more than one of the plurality of sensors 14 detects the presence of an object 20 in front of the primary automobile 10, the object 20 is categorized as a high confidence object.

The controller 16 is adapted to initialize an automatic lane change for the primary automobile 10 when the object 20 is categorized as a high confidence object. Referring to FIG. 2, the primary automobile 10 is traveling in the furthest right lane of a highway. The plurality of sensors 14 detects an object 20 that is either a stationary automobile 20A on the shoulder of the highway or an automobile 20B that is moving slower than the primary automobile 10 traveling in the same lane as the primary automobile 10. At point A, more than one of the plurality of sensors 14 detects the presence of the object 20, and initiates the automatic lane change, as indicated by arrow 22.

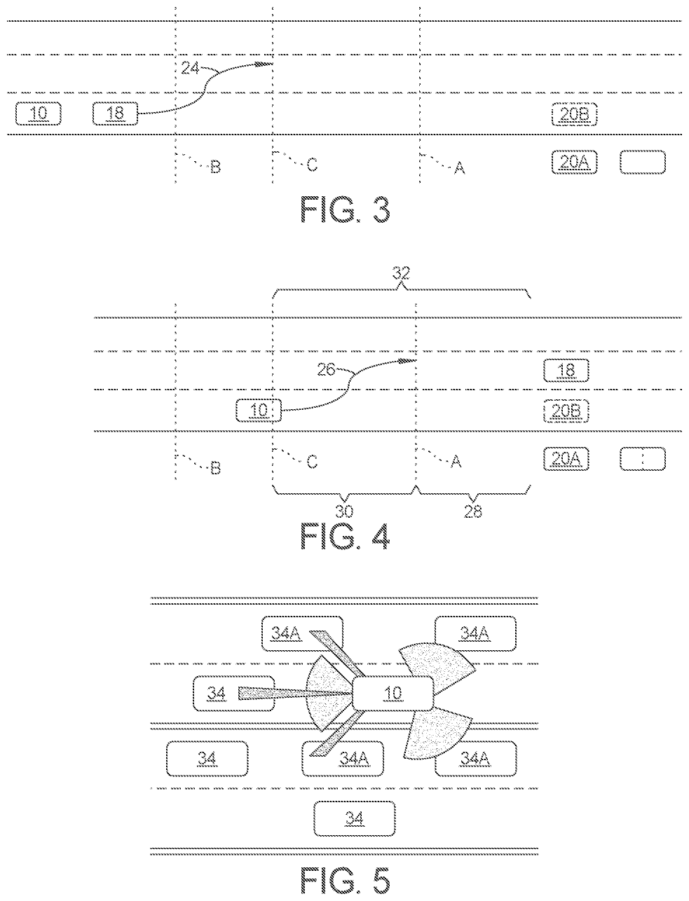

The controller 16 is also adapted to initialize an automatic lane change for the primary automobile 10 when the object 20 is categorized as a low confidence object and a lane change of the target automobile 18 is detected by at least one of the plurality of sensors 14 within the primary automobile 10. Referring to FIG. 3, the primary automobile 10 is travelling in the furthest right lane of the highway. The target automobile 18 is travelling in the furthest right lane of the highway in front of the primary automobile 10. At point B, the target automobile 18 makes a lane change, as indicated by arrow 24. At least one of the plurality of sensors 14 within the primary automobile 10 detects the lane change of the target automobile 18.

Referring to FIG. 4, at point C, a single one of the plurality of sensors 14 detects the presence of an object 20 that is either a stationary automobile 20A on the shoulder of the highway or an automobile 20B that is moving slower than the primary automobile 10 traveling in the same lane as the primary automobile 10. The controller 16 categorizes the object 20 as a low confidence object because the object 20 has only been detected by a single one of the plurality of sensors 14. This alone will not trigger initiation of an automatic lane change. The controller 16 initiates the automatic lane change, as indicated by arrow 26, when both a low confidence object and a lane change of the target automobile 18 is detected. This provides an early automatic lane change the gets initiated at point C, rather than at point A.

The initiation of an automatic lane change triggered by the detection of a high confidence object happens when more than one of the plurality of sensors 14 within the primary automobile 10 detects the object 20. Depending on the type and position of the plurality of sensors 14, this occurs at point A, giving the primary automobile 10 an amount of time, as indicated by 28, to complete the automatic lane change. The detection of a low confidence object occurs at point C, that occurs prior to point A. The amount to time between point A and point C is indicated by 30. The detection of a low confidence object alone is not sufficient to trigger an automatic lane change. However, the detection of a low confidence object in combination with the detection of a lane change of the target automobile 18 initiates the early automatic lane change, giving the primary automobile 10 more time to safely complete the automatic lane change, as indicated by 32. In order to trigger an automatic lane change, a lane change of the target automobile 18 must be detected within a pre-determined amount of time prior to the detection of a low confidence object, or anytime after the detection of a low confidence object and prior to the object 20 being categorized as a high confidence object.

In an exemplary embodiment, the plurality of sensors 14 are adapted to detect the presence of secondary automobiles 34 around the primary automobile 10 and communicate the presence of secondary automobiles 34 around the primary automobile 10 to the controller 16. The controller 16 is adapted to categorize each secondary automobile 34 detected around the primary automobile 10 as one of significant, wherein the secondary automobile 34 will interfere with the automatic lane change of the primary automobile 10, and insignificant, wherein the secondary automobile 34 will not interfere with the automatic lane change of the primary automobile 10. Referring to FIG. 5, secondary automobiles 34A that are adjacent the primary automobile 10 prevent the primary automobile 10 from safely changing lanes. Such secondary automobiles 34 are categorized as significant.

The controller 16 is adapted to initialize the automatic lane change for the primary automobile 10 when the object 20 is categorized as a high confidence object and all secondary automobiles 34 detected around the primary automobile 10 are categorized as insignificant. The controller 16 is also adapted to initialize the automatic lane change for the primary automobile 10 when the object 20 is categorized as a low confidence object and a lane change of the target automobile 18 is detected by at least one of the plurality of sensors 14 within the primary automobile 10 and all secondary automobiles 34 detected around the primary automobile 10 are categorized as insignificant.

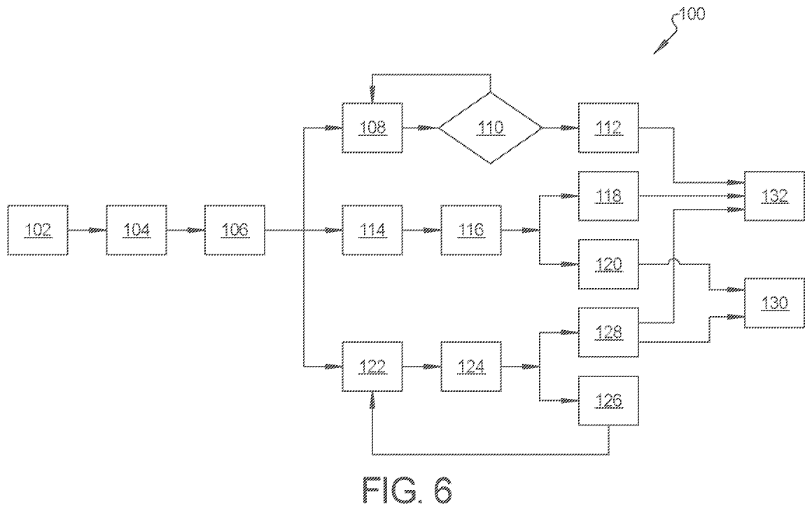

Referring to FIG. 6, a flow chart illustrating a method of initializing an automatic lane change in a moving primary automobile 10 is shown at 100. Starting at block 102, the method includes detecting a moving automobile that is in front of the primary automobile 10 with at least one sensor 14 within the primary automobile 10. Moving to block 104, the method includes communicating the detection of the moving automobile that is in front of the primary automobile 10 to the controller 16 and, moving to block 106, categorizing, via the controller 16 within the primary automobile 10, the moving automobile that is in front of the primary automobile 10 as a target automobile 18.

Moving to block 108, the target automobile 18 is monitored with at least one sensor 14 within the primary automobile 10 to detect a lane change by the target automobile 18. Moving to block 110, if no lane change is detected, the flowchart goes back to block 108, wherein the target automobile 18 will continue to be monitored. If a lane change is detected at block 110, then, moving to block 112, the method includes communicating the lane change of the target automobile 18 to the controller 16 within the primary automobile 10.

Simultaneously, while the target automobile 18 is being monitored at block 108, moving to block 114, the method includes detecting an object 20 in front of both the primary automobile 10 and the target automobile 18 with at least one sensor 14 within the primary automobile 10, and, moving to block 116, communicating the detection of the object 20 to the controller 16.

Moving to block 118, the controller categorizes the object 20 as a low confidence object when the object is detected by only one sensor 14 within the primary automobile 10. Moving to block 120, the controller 16 categorizes the object 20 as a high confidence object when the object is detected by more than one sensor 14 within the primary automobile 10.

Simultaneously, while monitoring the target automobile 18 at block 108 and detecting the object at block 114, moving the block 122, the method further includes detecting, with the plurality of sensors 14 within the primary automobile 10, the presence of secondary automobiles 34 around the primary automobile 10, and, moving to block 124, communicating the presence of secondary automobiles 34 around the primary automobile 10 to the controller 16.

Moving to block 126, the controller 16 categorizes each secondary automobile 34 detected around the primary automobile 10 that would interfere with an automatic lane change of the primary automobile 10 as significant. Moving to block 128, the controller categorizes each secondary automobile 34 detected around the primary automobile 10 that would not interfere with an automatic lane change of the primary automobile 10 as insignificant.

Moving to block 130, the controller 16 initializes the automatic lane change of the primary automobile 10 when the object 20 is categorized as a high confidence object at block 120 and all secondary automobiles 34 detected around the primary automobile 10 are categorized as insignificant at block 128.

Moving to block 132, the controller 16 initializes the automatic lane change of the primary automobile 10 when the object 20 is categorized as a low confidence object at block 118, and a lane change of the target automobile 18 is detected by at least one of the plurality of sensors 14 within the automobile at block 112, and all secondary automobiles 34 detected around the primary automobile 10 are categorized as insignificant at block 128.

A system and method of the present disclosure offers the advantage of initiating an automatic lane change when a lane change of a target automobile 18 is detected in combination with detection of an object 20 that is categorized as a low confidence object. This results in initiation of the automatic lane change earlier than the automatic lane change would have been initiated upon detection of a high confidence object.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of initializing an automatic lane change in a moving primary automobile, comprising:
categorizing, via a controller within the primary automobile, a moving automobile that is in front of the primary automobile as a target automobile;
categorizing, via the controller within the primary automobile, an object in front of both the primary automobile and the target automobile as one of a low confidence object and a high confidence object;
initializing, via the controller within the primary automobile, the automatic lane change for the primary automobile when the object is categorized as a high confidence object; and
initializing, via the controller within the primary automobile, the automatic lane change for the primary automobile when the object is categorized as a low confidence object and a lane change of the target automobile is detected by at least one of a plurality of sensors within the automobile.

2. The method of claim 1, wherein the categorizing, via the controller within the primary automobile, the moving automobile that is in front of the primary automobile as a target automobile further includes detecting the moving automobile that is in front of the primary automobile with at least one of a plurality of sensors within the primary automobile, and communicating the detection of the moving automobile that is in front of the primary automobile to the controller.

3. The method of claim 2, further including monitoring the target automobile with at least one of the plurality of sensors within the primary automobile to detect a lane change by the target automobile and communicating the lane change of the target automobile to the controller within the primary automobile.

4. The method of claim 3, wherein the categorizing the object in front of both the primary automobile and the target automobile as one of a low confidence object and a high confidence object further includes detecting the object with at least one of the plurality of sensors within the primary automobile and communicating the detection of the object to the controller.

5. The method of claim 4, wherein the categorizing the object in front of both the primary automobile and the target automobile as one of a low confidence object and a high confidence object further includes categorizing, with the controller, the object as a low confidence object when the object is detected by only one of the plurality of sensors within the primary automobile.

6. The method of claim 5, wherein the categorizing the object in front of both the primary automobile and the target automobile as one of a low confidence object and a high confidence object further includes categorizing, with the controller, the object as a high confidence object when the object is detected by more than one of the plurality of sensors within the primary automobile.

7. The method of claim 6, wherein the object is a stationary object that is located in one of the same lane as the primary automobile and a lane adjacent to a lane in which the primary automobile is moving.

8. The method of claim 6, wherein the object is an object that is moving slower than the primary automobile in one of the same lane as the primary automobile and a lane adjacent to a lane in which the primary automobile is moving.

9. The method of claim 6, further including verifying that conditions are safe for the automatic lane change prior to initializing the automatic lane change.

10. The method of claim 9, wherein verifying that conditions are safe for the automatic lane change prior to initializing the automatic lane change further includes detecting, with the plurality of sensors within the primary automobile, the presence of secondary automobiles around the primary automobile and communicating the presence of secondary automobiles around the primary automobile to the controller.

11. The method of claim 10, wherein verifying that conditions are safe for the automatic lane change prior to initializing the automatic lane change further includes categorizing, with the controller, each secondary automobile detected around the primary automobile as one of significant, wherein the secondary automobile will interfere with the automatic lane change of the primary automobile, and insignificant, wherein the secondary automobile will not interfere with the automatic lane change of the primary automobile.

12. The method of claim 11, wherein:
the initializing, via the controller within the primary automobile, the automatic lane change for the primary automobile when the object is categorized as a high confidence object further includes initializing, via the controller within the primary automobile, the automatic lane change for the primary automobile when the object is categorized as a high confidence object and all secondary automobiles detected around the primary automobile are categorized as insignificant; and
initializing, via the controller within the primary automobile, the automatic lane change for the primary automobile when the object is categorized as a low confidence object and a lane change of the target automobile is detected by at least one of a plurality of sensors within the automobile further includes initializing, via the controller within the primary automobile, the automatic lane change for the primary automobile when the object is categorized as a low confidence object and a lane change of the target automobile is detected by at least one of the plurality of sensors within the automobile and all secondary automobiles detected around the primary automobile are categorized as insignificant.

13. A system for controlling an automatic lane change within a moving primary automobile, comprising:
a plurality of sensors mounted within the primary automobile, and
a controller in communication with the plurality of sensors;
wherein, each of the plurality of sensors is adapted to detect a moving automobile that is in front of the primary automobile and the controller is adapted to categorize the moving automobile that is in front of the primary automobile as a target automobile;
each of the plurality of sensors is adapted to detect an object in front of both the primary automobile and the target automobile and the controller is adapted to categorize the object in front of both the primary automobile and the target automobile as one of a low confidence object and a high confidence object;
the controller is adapted to initialize the automatic lane change for the primary automobile when the object is categorized as a high confidence object; and
the controller is adapted to initialize the automatic lane change for the primary automobile when the object is categorized as a low confidence object and a lane change of the target automobile is detected by at least one of the plurality of sensors within the automobile.

14. The system of claim 13, wherein the controller is adapted to categorize the object in front of both the primary automobile and the target automobile as a low confidence object when the object is detected by only one of the plurality of sensors within the primary automobile.

15. The system of claim 14, wherein the controller is adapted to categorize the object in front of both the primary automobile and the target automobile as a high confidence object when the object is detected by more than one of the plurality of sensors within the primary automobile.

16. The system of claim 15, wherein the object is one of:
a stationary object that is located in one of the same lane as the primary automobile and a lane adjacent to a lane in which the primary automobile is moving; and
an object that is moving slower than the primary automobile in one of the same lane as the primary automobile and a lane adjacent to a lane in which the primary automobile is moving.

17. The system of claim 15, wherein the plurality of sensors is adapted to detect the presence of secondary automobiles around the primary automobile and communicate the presence of secondary automobiles around the primary automobile to the controller.

18. The system of claim 17, wherein the controller is adapted to categorize each secondary automobile detected around the primary automobile as one of significant, wherein the secondary automobile will interfere with the automatic lane change of the primary automobile, and insignificant, wherein the secondary automobile will not interfere with the automatic lane change of the primary automobile.

19. The system of claim 18, wherein:
the controller is adapted to initialize the automatic lane change for the primary automobile when the object is categorized as a high confidence object and all secondary automobiles detected around the primary automobile are categorized as insignificant; and
the controller is adapted to initialize the automatic lane change for the primary automobile when the object is categorized as a low confidence object and a lane change of the target automobile is detected by at least one of the plurality of sensors within the automobile and all secondary automobiles detected around the primary automobile are categorized as insignificant.

20. A method of initializing an automatic lane change in a moving primary automobile, comprising:
detecting a moving automobile that is in front of the primary automobile with at least one sensor within the primary automobile, communicating the detection of the moving automobile that is in front of the primary automobile to the controller, and categorizing, via a controller within the primary automobile, the moving automobile that is in front of the primary automobile as a target automobile;
monitoring the target automobile with at least one sensor within the primary automobile to detect a lane change by the target automobile and communicating the lane change of the target automobile to the controller within the primary automobile;
detecting an object in front of both the primary automobile and the target automobile with at least one sensor within the primary automobile, communicating the detection of the object to the controller;
categorizing, with the controller, the object as a low confidence object when the object is detected by only one sensor within the primary automobile;
categorizing, with the controller, the object as a high confidence object when the object is detected by more than one sensor within the primary automobile;
detecting, with the sensors within the primary automobile, the presence of secondary automobiles around the primary automobile and communicating the presence of secondary automobiles around the primary automobile to the controller;
categorizing, with the controller, each secondary automobile detected around the primary automobile as one of significant, wherein the secondary automobile will interfere with the automatic lane change of the primary automobile, and insignificant, wherein the secondary automobile will not interfere with the automatic lane change of the primary automobile
initializing, via the controller within the primary automobile, the automatic lane change for the primary automobile when the object is categorized as a high confidence object and all secondary automobiles detected around the primary automobile are categorized as insignificant; and
initializing, via the controller within the primary automobile, the automatic lane change for the primary automobile when the object is categorized as a low confidence object and a lane change of the target automobile is detected by at least one sensor within the automobile, and all secondary automobiles detected around the primary automobile are categorized as insignificant.
